(19) United States
(12) Patent Application Publication
(10) Pub. No.: US 2024/0058876 A1
(43) Pub. Date: Feb. 22, 2024

(54) DEBURRING TOOL FOR FORWARD AND REVERSE DEBURRING OF BORE EDGES

(71) Applicant: Heule Werkzeug AG, Balgach (CH)

(72) Inventor: Roman Faessler, Marbach (CH)

(21) Appl. No.: 18/332,294

(22) Filed: Jun. 9, 2023

(30) Foreign Application Priority Data
Jun. 10, 2022 (EP) 22178312.9

(51) Int. Cl. B23B 51/10

(52) U.S. Cl. CPC B23B 51/101; B23B 2260/004; B23B 2200/3681

(57) ABSTRACT

Deburring tool for deburring bores with a paired arrangement of cutting blades and a rotationally driven tool holder, wherein in a blade recess of a blade housing, the cutting blades are driven opposite one another with radially outwardly pointing conical cutting edges, so as to be radially displaceable relative to one another by means of a rotatable rocker arranged in a base body of the tool holder, and the rocker is mounted rotatably about an axial longitudinal axis in the tool holder and is resiliently biased in the axial direction, wherein in order to change the cutting blades, the blade housing is mounted axially displaceable and fixable on the rocker and the base body.

The invention relates to a deburring tool for forward and reverse deburring of bore edges

The novel design described below of a tool holder for deburring or chamfering bore edges with cutting blades arranged in pairs is a development of deburring tools, as described in DE 2649208 A1 [with reference number 1] and DE 102008046087 A1 [with reference number 2]. The description of the deburring tool contained in these two documents is part of the present description of the invention.

DE 26 49 208 C [1] shows a tool holder for deburring the edges of through-bores on either side with a tool head, which can be rotationally driven via a shaft and which has two cutting blades pointing essentially radially outward, and which are guided in receiving slots and pressed outward by a spring force, wherein the spring force can be transmitted to the cutting bodies by means of a rocker arranged rotatably about the longitudinal axis of the tool holder. The spring is designed as a torsion spring, which is attached on the tool housing and, furthermore, acts on the rocker, which is rotatable in a bore and which with pin-shaped extensions engages in slit-shaped recesses in the cutting blades.

Furthermore, this publication shows that the rotary movement of the rocker is limited by an externally operable setscrew, the tip of which rests against a contact surface of the rocker. The cone-shaped extensions of the rocker are to be disengaged from the cutting blades by means of a screw, which engages with an eccentric projection in a recess of the rocker.

DE 10 2008 046 087 A1 [2] shows a similar deburring tool for deburring bores with cutting blades arranged in pairs and a rotationally driven tool holder, wherein the cutting blades situated in a rectangular receiving slot (blade recess) are driven opposite one another with radially outwardly pointing conical cutting edges, so as to be radially displaceable relative to one another, by a rotatable rocker arranged inside the tool holder by means of rocker pins arranged on the end face of the rotary rocker.

The rocker is mounted in the tool holder, so that it can rotate about an axial longitudinal axis and is resiliently biased in the axial direction, with one rocker pin of the rocker engaging in one groove of the cutting blade in each case. The rocker is arranged in the blade housing of the deburring tool, such that it can be raised and lowered against the force of a torsion spring, and the spring bias of the torsion spring can be adjusted in a controlled fashion in the torsional direction.

The following additional publications are also known:

EP 0291563 B1 describes the design of cutting blades as used in the present invention. DE 2 407 269 A1 describes another way of guiding and resetting cutting bodies in a generic deburring tool.

The present invention is distinguished from the two publications DE 2649208 A1 [1] and DE 102008046087 A1 [2] in the following way:

The basic principle of the deburring tools described according to the invention remains that of providing two cutting blades arranged in pairs and directed toward one another in a rotationally driven tool holder, which are actuated by a rocker in their radial displacement out of the blade recess of the tool holder or into the blade recess. The rocker is designed as a dowel pin and is rotatably mounted about the axial longitudinal axis of the tool holder and rotationally biased by means of a torsion spring. Due to the special shape of the cutting blade, the edges of a bore are deburred, when the deburring tool moves forward into a bore, as well as when the deburring tool moves rearward out of the bore, whereby the opposite bore edge of the same bore is deburred. However, the technical teaching of the patent claims is not limited to the deburring of bore edges of a through bore on either side. One-sided deburring of only a single edge of the bore can also be provided without deburring the edge of the bore on the rear side of the through-bore. Similarly, deburring only the bore edge of a blind bore may be provided.

The invention is based on the two above-mentioned publications [1] and [2]. According to the subject matter of DE 10 2008 046 087 A1 [reference number=2], the rocker (22 [2]) is retracted for the blade change by means of an eccentric piece (25 [2]). This has the following drawbacks:
a) If the eccentric piece is not properly reset after the blade has been mounted, the rocker will not engage in the cutting blades and these can be lost in the machining process.
b) The rocker is retracted axially against the torsion spring (12 [2]). Due to the frictional forces, primarily generated by contamination caused during the machining process, the spring, which is primarily designed for torsion, is no longer able to reliably reset the rocker, such that it no longer engages in the cutting blades. In this case, the cutting blades can also be lost in the machining process.
c) The release of the rocker using the eccentric piece (25 [2]) and the associated components on the rocker is complex and cost-driving.

Based on DE 10 2008 046 087 A1, the invention is thus based on the general problem of developing a deburring tool, making its use simpler and more reliable. The operation of the tool and the adjustment of the deburring parameters would then be simpler, more operationally reliable and more accurate.

According to a first aspect of the invention, the object of the invention is therefore to provide operationally reliable blade change in a deburring tool.

This object is achieved by the teaching of independent claim 1. Advantageous embodiments are the subject of the further independent subsidiary claims and/or the subclaims.

A preferred embodiment thus provides that the blade change takes place by axial displacement of the blade housing relative to the rocker or the base body. This is advantageously achieved by loosening the already existing locking screws. In the prior art, the rocker was held in the base body, whereby it could be moved axially in order to allow the cutting blades to be exchanged. According to the invention, however, the blade housing is guided in an axially displaceable and lockable fashion on the axially non-displaceable rocker, which results in superior properties during a blade change.

Therefore, there is no longer any need, as in the prior art, for an eccentric piece and the components associated with the eccentric piece. The blade change is especially simple and reliable due to the axial displacement of the blade housing, which receives the rocker.

According to a second aspect of the invention, in the prior art there is a problem of adjusting the chamfer size of the deburred bore edge by controlled rotational adjustment of the rocker.

DE 2649208 A1 [1] shows a rocker, referred to there as an intermediate body (14 [1]), which is positioned adjustably in its radial position by means of a setscrew (17 [1]) in its rotational position and defines the radial position of the cutting blades (24 [1]) and thus the chamfer size of the bore edge. This results in the following drawbacks:
a) The adjustment screw can become misaligned during the machining process due to vibrations, and change or impair the chamfering result.
b) The radial position of the rocker cannot be set reproducibly, since there is no marking indicating the position of the rocker.
c) Adjusting the radial rocker position using this adjustment screw and the corresponding components on the rocker is complex and cost-driving.

According to this second aspect, the object of the invention is to adjust the radial position of the blade housing relative to the rocker in a reproducible manner by rotation and to refix it by designing a novel adjustment mechanism in order to adjust the chamfer size and to keep it process-safe.

DE 10 2008 046 087 A1 [2] showed that the blade housing (2 [2]) is always anchored radially in the same position with the base body (1 [2]) and that the chamfer size is adjusted by rotating the rocker relative to the base body. However, according to a preferred embodiment of the invention, it is provided that the rocker remains in the same stop position in the radial direction relative to the base body and the chamfer size is adjusted by rotating the blade housing relative to the rocker and the base body.

Thus, a combination of the first aspect of the invention and the second aspect is also preferably shown, although both aspects of the invention are also the subject matter of independent patent claims.

The combination of the two aspects consists in that the blade housing is mounted both axially displaceably and lockably on the rocker and the base body and adjustment piece receiving the rocker and, moreover, is also arranged on the rocker and the base body, so as to be radially rotatably adjustable and lockable. With this particular displacement and rotational position adjustment of the blade housing relative to the rocker and the base body, the first two aspects of the invention can be realized in combination. However, each aspect of the invention also has protection of its own.

According to a third aspect of the invention, DE 10 2008 046 087 A1 [2] showed that the radial biasing of the rocker with the torsion spring for the reset force of the cutting blades can be adjusted by the clamping head (5 [2]) and index pin (6[2]) elements. However, this results in the following drawbacks:
a) The biasing force on the rocker and thus the displacement pressure on the cutting blades can only be adjusted stepwise (indexed), i.e. not steplessly.
b) The prior art does not allow a tool shaft to be adapted in order to clamp the tool holder with a different diameter than that of the base body (1 [2]) in the machine tool. This is because the fastening of the clamping head (5[2]) selected according to the state of the art neither allows for the necessary concentric running (accuracy), nor the necessary rigidity for the use of such a shaft.

Thus, according to a third aspect, the object of the invention is to achieve through the design of a novel adaptation both the use of a shaft and the stepless, reproducible and process-safe bias of the rocker.

In order to achieve the stated object, an independent claim proposes that the shaft be frictionally locked by means of two diametrically opposed locking screws, which engage in an annular groove on the shaft side. By loosening these locking screws, the torsion spring can be steplessly biased by turning the shaft radially. By subsequently fixing the shaft, the adjusted bias is reliably maintained in a process-reliable manner. The reproducibility of the position is ensured by corresponding markings on the shaft and the base body.

All three aspects of the invention, in any combination with one another and/or individually, lead to a novel concept for a deburring tool, as described below with reference to the drawings.

The subject matter of the present invention results both from the subject matter of the individual claims, and also from the combination of the individual claims with one another.

All the details and features disclosed in the documents, including the abstract, in particular the spatial formation shown in the drawings, could be claimed as essential to the invention, insofar as they are novel, individually or in combination, compared with the prior art. The use of the terms “essential” or “in accordance with the invention” or “essential to the invention” is subjective and does not imply that the features thus designated must necessarily be part of one or more claims.

In the following, the invention is explained in more detail with the aid of drawings, which depict only one way of carrying out the invention. Further features and advantages of the invention, which are essential to the invention, are apparent from the drawings and their description.

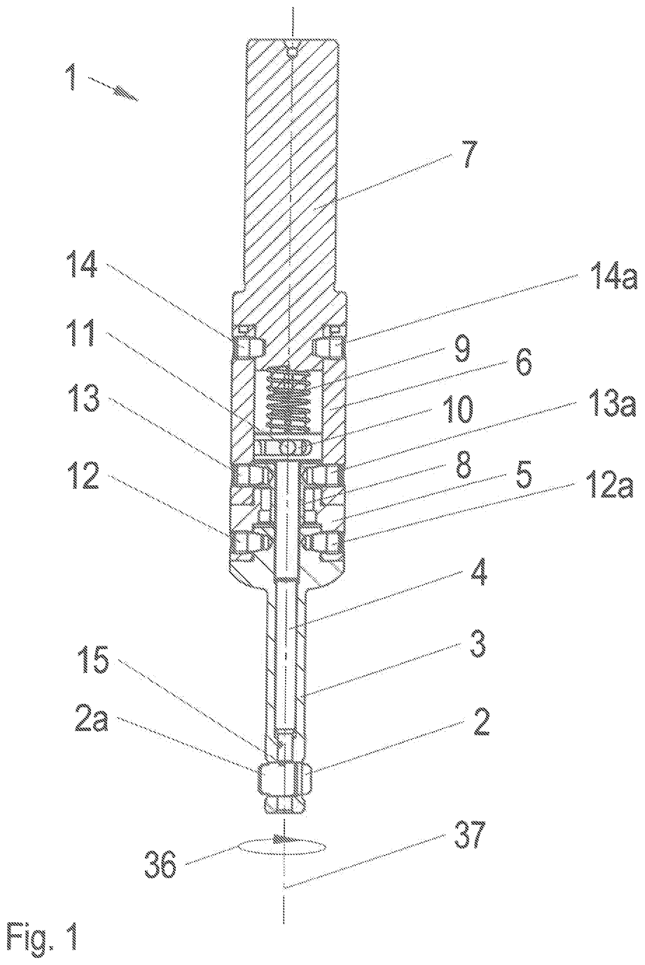

FIG. 1: Sectional view through the tool holder providing a general overview

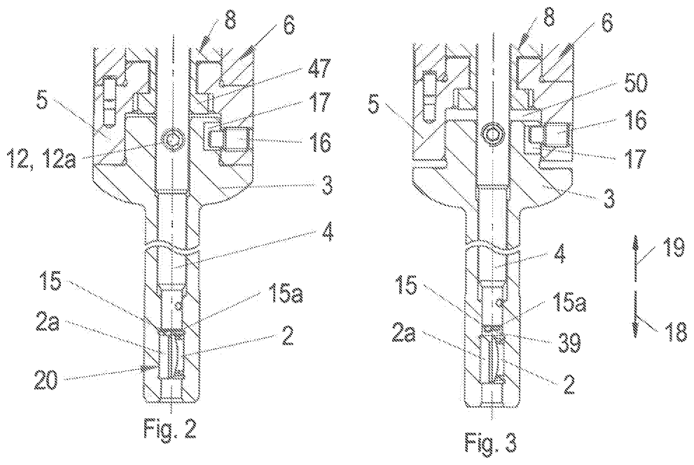

FIG. 2: Sectional view through the tool holder showing the principle of a blade change (rocker engaged)

FIG. 3: Sectional view through the tool holder illustrating the blade-change principle (blade free for change)

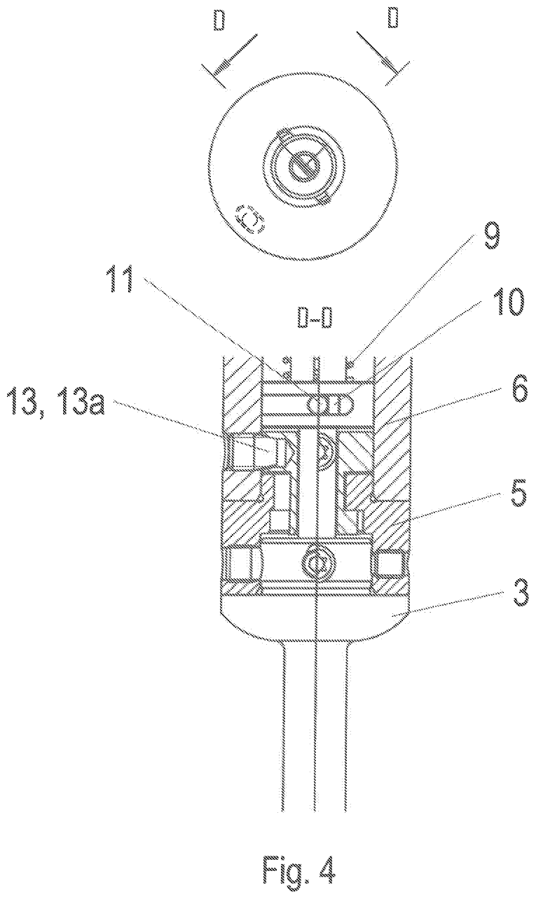

FIG. 4: Sectional view through the tool holder illustrating the principle of adjusting the chamfering and deburring size (loosening and fastening the adjustment piece)

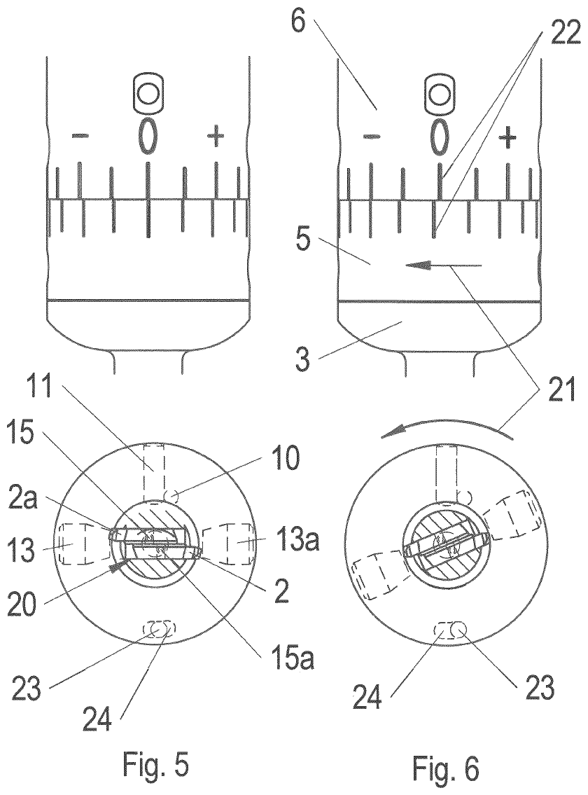

FIG. 5: Side view of the tool holder showing the principle of adjusting the chamfering and deburring size (example position 1)

FIG. 6: Side view of the tool holder illustrating the principle of adjusting the chamfer and deburring size (example position 2)

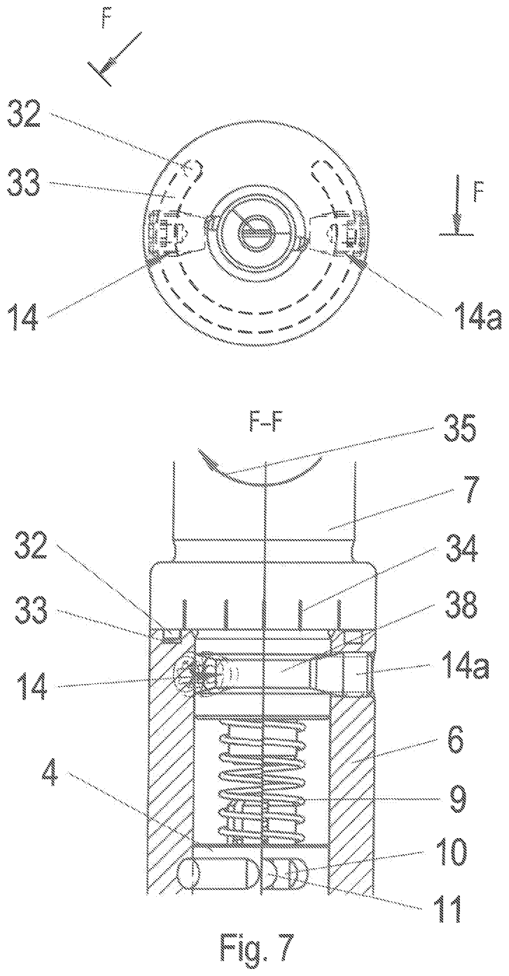

FIG. 7: Sectional view through the tool holder illustrating the principle of rocker spring bias

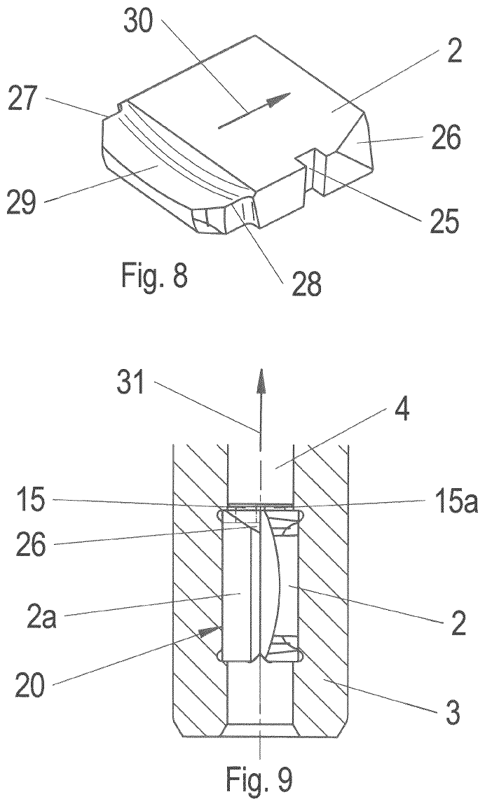

FIG. 8: Perspective view of a cutting blade

FIG. 9: Sectional view through the tool holder illustrating the principle of changing blades (insertion of the blades)

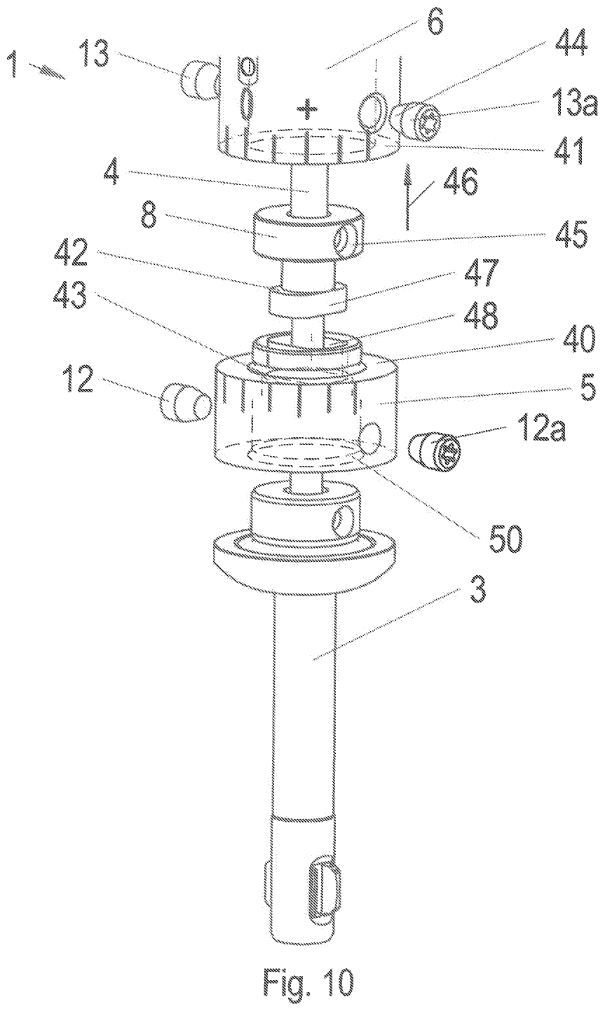

FIG. 10: Exploded view of the essential parts of the deburring tool

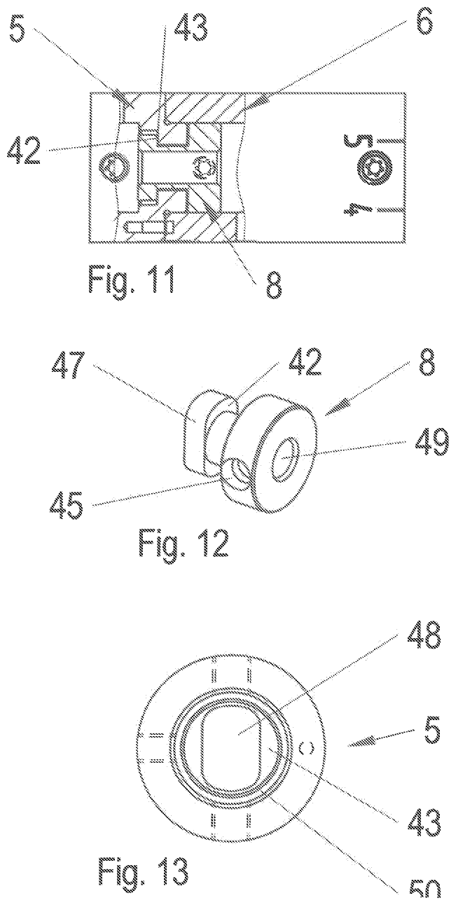

FIG. 11: Detachable connection between the adjustment piece, the clamping piece and the base body

FIG. 12: Perspective representation of the clamping piece

FIG. 13: View of the adjustment piece from the connection side

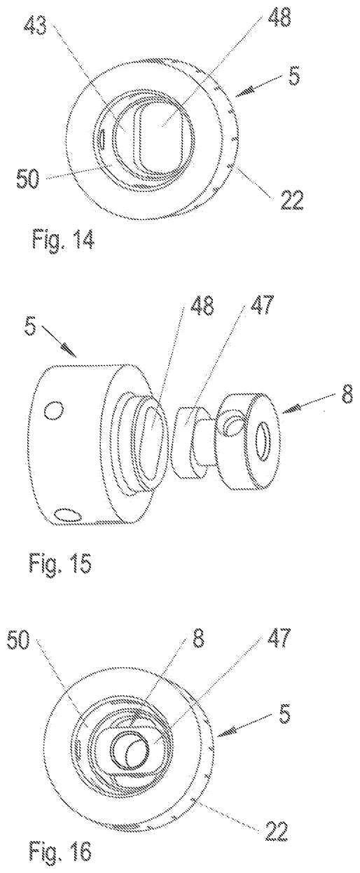

FIG. 14: View of the adjustment piece from the inside

FIG. 15: Perspective representation of the assembly of the clamping piece and the adjustment piece

FIG. 16: View of the interior of the adjustment piece with coupled clamping piece

BASIC FUNCTION OF THE TOOL HOLDER 1

The tool holder 1, which is driven to rotate in the direction of rotation 36, is used to apply chamfers or deburs to the front and/or rear bore edges. The tool axis 37 is aligned with the center axis of the bore to be deburred.

The tool holder 1 works with two cutting blades 2, 2a acting diametrically opposite one another. Such a cutting blade 2, 2a and its drive is described, e.g., in EP 0 291 563 B1. Reference is made to the disclosure therein. Since the cutting blades 2, 2a are of identical design, it suffices to include only one cutting blade 2 in the following description.

According to FIGS. 2 and 3, the cutting blades 2, 2a are held in their extended position by a spring-loaded cylindrical rocker 4 rotating in the tool axis 37 by means of rocker pins 15, 15a directed in the axial direction, which engage in pin grooves 25 in the upper sides of the cutting blades 2, 2a. This position also defines the radial position of the cutting edges 27, 28 of the cutting blades 2, 2a according to FIG. 8 and thus the size of the debur or chamfer.

According to FIG. 4, the rocker 4 is held in a basic position relative to the base body 6 by its radially pointing stop pin 10, which rests against a stop pin 11 of the base body 6, spring-loaded relative to the base body 6.

In the opposite direction, the rocker 4 can rotate freely against the spring bias of a torsion spring 9. According to FIG. 1, the torsion spring is supported by its upper end on an axial extension of the shaft 7, while the lower end is connected to an axial extension of the rocker 4.

During the machining process, when the chamfering or deburring size has been reached, the cutting blades 2 can retract due to the process forces and glide through the bore to be deburred in order to emerge from the bore on the opposite side and reach their extended position under spring load.

In the process, the rocker 4 is twisted against the spring force of the torsion spring 9 and further biased. This biasing then drives the cutting blades 2 radially outward again for the next process step of further deburring.

Moreover, with an axial rearward movement of the rotationally driven tool holder 1, the rear bore edge can thus be deburred or chamfered.

The invention thus describes a novel concept of a deburring tool which, in isolation or in any desired combination, has the following features:
1. For the machining of workpieces with this tool, it must be possible to exchange the cutting blades 2 from time to time,
2. adjust the chamfer or deburring size, and
3. change the biasing force of the rocker 4.

These features are described in the following:

1. Change of the Cutting Blades 2 (FIGS. 2, 3, 8, and 9)

The cylindrical pin-shaped rocker 4 is rotatably mounted in a blade housing 3, at the lower end of which a window-like blade recess 20 is arranged for the mounting of the cutting blades 2, 2a placed there.

According to FIGS. 1-3, diametrically opposed threaded bores are arranged in the blade housing 3, into each of which a locking screw 12, 12a is screwed. In the clamped position, each locking screw 12, 12a is supported by its pin-side end on the outer circumference of the rocker 4.

By loosening the locking screws 12, 12a in order to fasten the blade housing 3, the blade housing 3 can be pulled forward in the axial direction of the arrow 18 relative to the rocker 4. This is obvious by comparing FIGS. 2 and 3. The rocker 4 thus forms the bearing body for the displacement of the blade housing 3, which is movably mounted on the rocker 4. Thus, the cutting blades 2, 2a, which are mounted in the blade recess 20 in the base body 6, also move forward with the axial displacement of the blade housing 3. This causes the two rocker pins 15, 15a to lose their engagement in the pin grooves 25 of the cutting blades 2, 2a, whereby the blades are released and can be removed from the blade recess 20. This process can be seen when comparing FIG. 2 and FIG. 3. The blade housing 3 is displaceable with an inner, center axial extension and fixable in the direction of rotation while held in a center bearing support 50 in an adjustment piece 5. According to FIG. 3, the axial feed movement of the blade housing 3 in the center bearing holder 50 in the direction of arrow 18 on the rocker 4 held in the tool holder 1 creates a clearance 39 between the inner end face of the blade housing 3 and the opposite end face of the base body 6, and because of this axial clearance, the rocker pins 15, 15a disengages with the blade-side pin grooves 25. This makes it possible to remove the cutting blades 2, 2a from the blade recess 20 and replace them with new cutting blades.

To prevent the blade housing 2 from being pulled completely out of the bearing holder 50 during this action and prevent it from losing its orientation for its refastening by means of locking screws 12, 12a, the adjustment piece 5a has a limiting screw 16, which engages in a limiting groove 17 in the blade housing 3 and restricts the movement of the blade housing 2 both radially and axially.

According to FIGS. 10-16, the adjustment piece 5 is a cylindrical sleeve, which has the lower bearing seat 50, open on one side in the axial direction, in which a center axial projection of reduced diameter of the blade housing 3 engages and where it is received in a displaceable and fixable manner. The adjustment piece 5 is connected to the lower end face of a clamping piece 8 via bearing pins, as shown in FIGS. 2 and 3.

Before inserting new cutting blades 2, 2a, the blade housing 3 is first retracted in the direction of the arrow 19 and refastened in a form-fitting manner with the adjustment piece 5 by means of locking screws 12, 12a. Thereupon, the new cutting blades 2, 2a can be inserted independently of one another, and one after the other, in the direction of the arrow 30 into the blade recess 20 in the blade housing 6. In the process, the insertion bevels 26 of the cutting blades 2, 2a provided for this purpose press the rocker 4 rearward in the axial direction of arrow 31 (see FIG. 9) and the rocker pins 15, 15a of the rocker 4, which is now also axially resiliently biased, re-engage in the pin grooves 25 (see FIG. 8) and fasten the cutting blades 2, 2a, including in the radial direction.

2. Chamfer Diameter Adjustment Mechanism (FIGS. 4, 5 and 6)

In the basic position of the tool holder 1, before the planned chamfer or deburring is applied, the rocker 4 is in a spring-loaded fixed position relative to the base body 6. The rocker 4 stop pin 10 and the stop pin 11 components in the base body 6 hold the rotating spring-loaded rocker 4 in one direction in this fixed position, since the torsional force of the torsion spring 9 presses the rocker-side stop pin 10 against the stop pin 11 on the base body side.

In order to now set or adjust the chamfering or deburring size, the blade housing 3 needs to be rotated in the circumferential direction relative to the rocker 4 and thus the base body 6. The components required to carry out this adjustment process steplessly and with sufficient accuracy are the adjustment piece 5, the clamping piece 8, and the locking screws 13, 13a. They connect the blade housing 3 to the base body 6 both detachably and in a fixed state with sufficient accuracy to ensure concentricity of the blade housing 3 and provide sufficient frictional fit in order to transmit the cutting forces to the shaft 7.

When the tool is assembled, a connection is made between the adjustment piece 5 and the clamping piece 8, which is maintained throughout the entire service life of the tool. This is advantageously done by performing the measures described below.

The recess 48 on the upper side of the adjustment piece 5 is designed, such that during tool assembly, the cam 47 on the clamping piece 8 can be inserted through the recess 48 into the adjustment piece 5 in a certain rotational position, whereupon it engages internally in the adjustment piece 5 by subsequent twisting. The recess 48 matches approximately the shape of the cam 47 and serves only to insert the cam 47 into the adjustment piece 5. The recess 48 no longer has any function during operation.

The elongated shape of the cam 47 and correspondingly that of the recess 48 in the adjustment piece 5 are intended, during assembly, for the cam 47, with an internal rotation of approximately 90°, to find a counter surface in the adjustment piece 5, i.e., the contact surface 43, and be able to pull the adjustment piece 5 toward the base body 6. Accordingly, this concerns a rotary plug-in connection between the clamping piece 8 connected to the cam 47 and the adjustment piece 5 detachably connected thereto, for the purpose of assembly, is thereby connected to the base body 6.

In another preferred embodiment, such a detachable connection may also be designed in the form of a kinematic inversion of the rotary plug-in connection described above. The cam 47 is formed on the adjustment piece 5 in an axial extension and engages in a form-fitting recess 48 in the clamping piece 8 in the manner of the rotary plug-in coupling described above.

In addition to this kinematic inversion of a releasable plug-in rotary coupling connection, there are other preferred embodiments for connecting the three aforementioned parts 5, 6, 8. For example, a magnetic coupling may be provided for coupling these parts in a releasable way. Likewise, the end face of one part may have a plurality of circumferentially distributed cams, which engage in similar-type recesses, distributed over the circumference, on the opposite part.

Neither the adjustment piece 5 nor the clamping piece 8 with its cam 47 are in fixed connection with the rocker 4. The rocker 4 reaches freely through these components 5, 8 and can be moved freely both axially and radially relative to these components 5, 8.

Accordingly, according to FIG. 11, the adjustment piece 5 is detachably connected to the base body 6 via the clamping piece 8. As shown in FIG. 12, the oval or rectangular cam 47 is formed on the clamping piece 8 in axial extension. FIG. 13 shows a view of the adjustment piece 5 as seen from the connection side to the base body 5. FIG. 14 shows the view of the interior of the adjustment piece 5 with contact surface 43.

FIG. 15 shows the view of the adjustment piece 5 and the clamping piece 8 in the orientation in which the cam 47 of the clamping piece 8 can be inserted into the adjustment piece 5 during assembly of the tool. FIG. 16, furthermore, shows a view of the interior of the adjustment piece 5 with the now transverse cam 47 of the clamping piece 8, which has the task of drawing the adjustment piece 5 detachably and, in the released state, also rotatably toward the base body 6.

In this case, it is provided that the adjustment piece 5 is rotatably in contact with the base body 6 by means of said cam 47 in the released state for the setting or adjustment of the chamfer size and that in the fixed state, the cam 47 pulls the adjustment piece 5 axially toward the base body 6, such that due to the resulting frictional forces at this connection, the adjustment piece 5 is also fixed radially (in the direction of rotation) to the base body 6.

In one respect, the clamping piece 8 enables stepless adjustment of the chamfer size and ensures that the setting made does not change, when the adjustment piece 5 is fastened. For this purpose, the cylindrical pin-like rocker 4, as shown in FIG. 10, engages through the center bore 49 of the clamping piece 8.

The cylindrical adjustment piece 5 receives the clamping piece 8 with its center recess 48.

By loosening the locking screws 13, 13a, the frictional fit between the base body 6 and the adjustment piece 5 is removed and the cutting blades 2, 2a can be radially displaced and adjusted according to FIG. 7 by turning the blade housing 3, e.g., in direction 21 relative to the rocker 4 via the eccentric gear formed by the rocker pins 15, 15a and the blade-side pin grooves 25. The markings 22 on the base body 6 and the adjustment piece 5 shown in the upper part of FIGS. 5 and 6 help to adjust the rotational position of the blade housing 3 in a scaled and reproducible manner. The maximum range of adjustment is thereby restricted by the engagement of the limiting pin 23 in the adjustment piece 5 in the limiting groove 24 in the base body 6, such that the cutting blades 2, 2a cannot be moved beyond the geometrically defined range in the radial direction. When tightening the locking screws 13, 13a on the base body, which engage with their pin ends in radially outwardly directed conical surfaces 45 in the clamping piece 8, the frictional fit between the adjustment piece 5 and the base body 6 is restored by means of the clamping piece 8 and the two components 5, 6 are fastened to one another without the set adjustment being shifted.

3. Adjusting the Spring Bias of the Torsion Spring 9 (FIG. 7)

The novel tool design makes it possible to use of a shaft 7 for adapting the tool holder 1 in the machine tool. The shaft 7 is thus connected to a motor-driven rotationally driven chuck (not shown in the drawings) in the machine tool. The adjustment of the radially acting spring bias of the rocker 4, i.e., the biasing torque on the cutting blades 2, 2a, which is necessary for machining different materials, is advantageously integrated into the connection of the base body 6 and the shaft 7. The cutting force is transmitted via the torsional load-transmitting connection between the base body 6 and the shaft 7 by means of the locking screws 14, 14a in the base body 6. Thus, the locking screws 14, 14 a in the base body 6 engage in an annular groove 38 in the shaft 7. According to FIG. 7, the torsion spring 9 is connected with its upper end to an axial projection on the bottom of the shaft 7, while the other end is connected to an axial projection of the rocker 4.

When loosening the two locking screws 14, 14a, the shaft 7 can, for example, be rotated in the direction of arrow 35 relative to the base body 6 and in this case tension the torsion spring 9 and relax it in the opposite direction. Subsequent tightening of the locking screws 14, 14a restores the force-transmitting connection between the shaft 7 and the base body 6. The diametrically opposed locking screws 14, 14a also allow the necessary accuracy of the connection in order to ensure concentricity of the tool holder 1, as a whole. The markings 34 on the base body 6 and the shaft 7 allow scalable and reproducible adjustment of the preload force of the torsion spring 9. The maximum desired adjustment range is thereby limited in the circumferential direction by the limiting pin 32 in the shaft 7 and limiting groove 33 elements in the base body 6.

From the exploded view of FIG. 10, further details of the deburring tool according to the invention can be seen.

In the fixed state, the blade housing 3, adjustment piece 5 and base body 6 parts are firmly connected to one another via the locking screws 12, 12a in the blade housing 3. The adjustment piece 5 is connected to the base body 6 in an adjustable and lockable manner in the axial direction of the arrow 46 by means of the clamping piece 8. The clamping piece 8 is detachably connected to the base body 6 by means of the locking screws 13, 13a. In this case, the pin-side conical surfaces 44 of the locking screws 13, 13a engage in the approximately identical bore-side conical surfaces 45 in the clamping piece 8.

The clamping piece 8 engages with its cam 47 arranged on the underside in the interior of the adjustment piece 5 in a form-fitting recess 48 arranged there, such that the cam contact surface 42 on the clamping-piece side rests against the inner contact surface 43 of the adjustment piece 5.

By fastening the two locking screws 13, 13a on the base body side in the radially outwardly directed conical surfaces 45 in the clamping piece 8, which are designed as bores, the clamping piece 8 is moved axially into the base body 6 in the direction of arrow 46 and tightens the adjustment piece 5 against the base body 6 in the axial direction. The upper, end-face contact surface 40 of the adjustment piece 5 rests against the opposite contact surface 41 of the base body 6 and establishes the necessary radially acting frictional fit. Thus, the adjustment piece 5 is fixed axially by positive form fitting and radially by frictional fit with the base body 6. The rocker 4 remains mounted, such that it can rotate and move axially relative to the parts of the blade housing 3, i.e., adjustment piece 5 and clamping piece 8. By slightly loosening locking screws 13, 13a, the radially acting frictional fit between the base body 6 and the adjustment piece 5 is removed and the adjustment piece 5, together with the blade housing 3 fixed thereto, can be rotationally adjusted relative to the base body 6. This allows for the chamfering or deburring size to be set or adjusted. This connection between the adjustment piece 5 and the base body 6 is therefore established by means of the clamping piece 8, such that when these two parts are fixed in place, no interfering forces occur during rotation which again impair the exact adjustment during the fixation. The clamping piece 8 serves only as a connecting piece in order to ensure an exclusively axially directed movement.

The axial movement in the direction of arrow 46 in order to lock the adjustment piece 5 by means of clamping piece 8 and base body 6 parts is triggered by the engagement of the outer conical surfaces 44 of the locking screws 13, 13a in the inner conical surfaces 45 of clamping piece 8.

### REFERENCE NUMERAL LIST

1 Tool holder
2 Cutting blades
2a Cutting blade
3 Blade housing
4 Rocker
5 Adjustment piece
6 Base body
7 Shaft
8 Clamping piece
9 Torsion spring
10 Stop pin (rocker)
11 Stop pin (base body)
12 Locking screw (blade housing)
12a Locking screw (blade housing)
13 Locking screw (adjustment piece)
13a Locking screw (adjustment piece)
14 Locking screw (shaft)
14a Locking screw (shaft)
15 Rocker pin
15a Rocker pin
16 Check screw
17 Limiting groove (blade housing)
18 Arrow direction
19 Arrow direction
20 Blade recess
21 Arrow direction (adjustment piece)
22 Marking (chamfer size)
23 Limit pin (adjustment piece)
24 Limiting groove (base body)
25 Pin groove (blade)
26 Lead-in bevel
27 Cutting edge (forward)
28 Cutting edge (rearward)
29 Chip recess
30 Arrow direction (blade)
31 Arrow direction (rocker)
32 Limiting pin (shaft)
33 Limiting groove (base body)
34 Marking (spring bias)
35 Arrow direction (shaft)
36 Direction of rotation
37 Tool axis
38 Annular groove (shaft)
39 Clearance
40 Rear contact surface (adjustment piece)
41 Contact surface (base body)
42 Cam contact surface (clamping piece)
43 Internal contact surface (adjustment piece)
44 External conical surfaces (from 13, 13a)
45 Internal conical surfaces (clamping piece)
46 Arrow direction
47 Cam (clamping piece)
48 Recess
49 Center bore (in 8)
50 Bearing support (in 5 for 3)

1. A deburring tool for deburring bores with a paired arrangement of cutting blades and a rotationally driven tool holder, wherein in a blade recess of a blade housing, the cutting blades are driven opposite one another with radially outwardly pointing conical cutting edges, so as to be radially displaceable relative to one another by means of a rotatable rocker arranged in a base body of the tool holder, and the rocker is mounted in the tool holder rotatably about an axial longitudinal axis and is resiliently biased in the axial direction, wherein for changing the cutting blades, the blade housing is mounted on the rocker and the base body, so as to be axially displaceable and fixable.

2. The deburring tool according to claim 1, wherein the rocker engages with axially directed rocker pins in blade-side pin grooves situated in the upper sides of the cutting blades, and in that the rocker pins can be disengaged from the blade-side pin grooves by axial displacement of the blade housing on the rocker in order to exchange the blades.

3. The deburring tool according to claim 1, wherein in order to fasten the relative displacement position between the blade housing and the rocker, one or more locking screws are arranged in an adjustment piece and can be placed with their ends on the pin side against the blade housing.

4. The deburring tool according to claim 3, wherein in order to limit the axial displacement of the blade housing, a limiting screw is provided, which is arranged in the adjustment piece in the radial direction and engages with its pin-side end in an axially directed limiting groove in the blade housing.

5. The deburring tool according to claim 1, wherein for exchangeable connection of the cutting blades to the rocker, the axial rocker pins are arranged at the lower end of the rocker and interact in a spring-loaded manner with the insertion bevels on the cutting blades leading into the pin grooves.

6. The deburring tool according to claim 5, wherein each cutting blade can be inserted individually into the blade recess in the blade housing, and that in the process, the insertion bevels of the cutting blades press the rocker, spring-loaded in the axial direction of the arrow, against a torsion spring, and the rocker pins of the spring-loaded rocker engage in the blade-side pin grooves and fasten the cutting blades in the radial direction in the blade recess in the blade housing.

7. A deburring tool for deburring bores with a paired arrangement of cutting blades and a rotationally driven tool holder, wherein in a blade recess of a blade housing, the cutting blades are driven opposite one another with radially outwardly pointing conical cutting edges, so as to be radially displaceable relative to one another by means of a rotatable rocker arranged in a base body of the tool holder, and wherein the rocker is mounted in the tool holder rotatably about an axial longitudinal axis and is resiliently biased in the axial direction, wherein in order to set the chamfer size of a bore edge, the radial rotational position of the blade housing relative to the rocker and the base body can be rotated and fastened steplessly.

8. The deburring tool according to claim 1, wherein a stop pin of the rocker and a stop pin in the base body hold the rotationally spring-loaded rocker in a fixed stop position in the blade housing in one direction of rotation.

9. The deburring tool according to claim 8, wherein the torsional force of the torsion spring biases the rocker-side stop pin against the stop pin on the base body side in the one-sided stop position of the rocker.

10. The deburring tool according to claim 1, wherein the cylindrical adjustment piece connected to the base body is detachably coupled at the end face to a cylindrical clamping piece.

11. The deburring tool according to claim 1, wherein radially inwardly directed locking screws are arranged in the base body and adjustably connect the adjustment piece to the base body by means of the clamping piece, both detachably and in a fixed state, in order to transmit the cutting forces to the shaft.

12. The deburring tool according to claim 7, wherein the continuous adjustment of the chamfer size of the bore edge is performed by turning the adjustment piece relative to the base body, and when fastening the adjustment piece by means of the internal clamping piece, the setting made for the chamfer size is fixed.

13. The deburring tool according to claim 7, wherein by loosening the locking screws on the base body side, the frictional fit between the base body and the adjustment piece is removed, and in that the cutting blades are radially displaceable and adjustable by turning the blade housing relative to the rocker via the eccentric gear formed by the rocker pins and blade-side pin grooves.

14. The deburring tool according to claim 7, wherein in order to adjust the rotational position of the blade housing in a scaled and reproducible manner, markings are provided on the base body opposite to markings on the adjustment piece.

15. The deburring tool according to claim 14, wherein in order to limit the maximum adjustment range of the cutting blades, a limiting pin in the adjustment piece engages in a limiting groove in the base body.

16. The deburring tool according to claim 7, wherein when the locking screws on the base body side are tightened against the clamping piece, the frictional fit between the adjustment piece and the base body can be restored.

17. A deburring tool for deburring bores with a paired arrangement of cutting blades and a rotationally driven tool holder, wherein in a blade recess of a blade housing, the cutting blades are driven opposite one another with radially outwardly pointing conical cutting edges, so as to be radially displaceable relative to one another by means of a rotatable rocker arranged in a base body of the tool holder, wherein the rocker is mounted in the tool holder rotatably about an axial longitudinal axis and resiliently biased in the axial direction by means of a torsion spring, wherein for reproducible and process-reliable biasing of the rocker, the torsion spring can be biased by radially rotating the shaft.

18. The deburring tool according to claim 17, wherein the biasing torque of the rocker required for machining different materials is integrated into the connection of the base body and the shaft by adjusting the radially acting spring bias of the rocker.

19. The deburring tool according to claim 17, wherein the shaft can be fixed in a rotational position on the base body by means of locking screws on the base body side.

20. The deburring tool according to claim 17, wherein markings on the base body and the shaft provide scalable and reproducible adjustment of the biasing force of the torsion spring.

21. The deburring tool according to claim 17, wherein the maximum adjustment range during the rotation of the shaft is provided by a limiting pin in the shaft, which engages in a limiting groove in the base body.

22. The deburring tool according to claim 1, wherein in the fixed state, the blade housing, the adjustment piece and the base body are firmly connected to one another, and in that the connection of the adjustment piece to the base body is obtained by means of the clamping piece in the axial direction of the arrow.

23. The deburring tool according to claim 1, wherein the clamping piece is detachably connected to the base body by means of the locking screws.

24. The deburring tool according to claim 23, wherein the clamping piece is detachably coupled to the adjustment piece.

25. The deburring tool according to claim 23, that wherein the detachable coupling between clamping piece and adjustment piece is formed as a plug-in rotary coupling.

26. The deburring tool according to claim 17, wherein the chamfer or deburring size can be set or adjusted, in that when the two tapered locking screws arranged in the base body are fixed in associated radially directed conical surfaces arranged in the clamping piece, the clamping piece can be moved into the base body in the axial direction of the arrow, thereby tightening the adjustment piece in the axial direction against the base body.

27. The deburring tool according to claim 1, wherein the adjustment piece is connected axially by positive form fit and radially by frictional fit to the base body, and in that the rocker remains mounted rotatably and axially displaceably relative to the blade housing, the adjustment piece and the clamping piece.

28. The deburring tool according to claim 1, the form fit of adjustment piece and base body is obtained by means of the clamping piece, such that when these two parts are fastened, no forces occur which act in the direction of rotation in an interfering manner, which would impair the precise adjustment during fastening.
